(19) United States
(12) Patent Application Publication
(10) Pub. No.: US 2026/0025223 A1
(43) Pub. Date: Jan. 22, 2026

(54) SYSTEMS AND METHODS FOR LAYERED APPLICATION PROGRAM INTERFACE FOR VEHICLE APPLICATIONS

(71) Applicant: TOYOTA JIDOSHA KABUSHIKI KAISHA, Toyota-shi (JP)

(72) Inventors: Michael Joseph LOWE, Tokyo (JP); Daniel Felix Nguyen Olbrys, Tokyo (JP)

(73) Assignee: TOYOTA JIDOSHA KABUSHIKI KAISHA, Toyota-shi (JP)

(21) Appl. No.: 18/773,864

(22) Filed: Jul. 16, 2024

(51) Int. Cl. H04L 1/00

(52) U.S. Cl. CPC H04L 1/0028; H04L 1/0026

(57) ABSTRACT

Provided are an apparatus and method for providing an interface for vehicle applications. The apparatus may include a memory storing instructions; and at least one processor configured to execute the instructions to provide a layered application programming interface (API) comprising: a direct interface layer comprising at least one signal source; a unit conversion layer configured to receive signal data from at least one signal source and convert the signal data into a standardized format; and a processing layer configured to process the converted signal data from the unit conversion layer into processed signal data which can be interpreted by at least one application.

Systems and methods consistent with example embodiments of the present disclosure relate to layered application program interface (API) for vehicle applications.

### BACKGROUND

In the related art, applications involving vehicles may be developed in order to perform various functions. For example, in the case of a self-driving vehicle, a variety of sensor data may need to be collected for feedback and processed to perform corrective action on steering. A variety of interfaces and variables may be created, for example, each sensor may define its own interface, and raw data may be collected, converted, processed, before being used by the application.

The related art may introduce too many interfaces and variables to be able to manage efficiently. In particular, vehicle software may be highly complex and difficult to abstract because of the large number of variables and dependencies of both hardware and software. For example, each sensor may use different firmware, so a method for handling an interaction for one sensor may be completely different for a second sensor. Additionally the units output from the sensor may be different.

As a result of the complex nature of vehicle software, troubleshooting any errors that happen during implantation of code may be very difficult, as it is hard to trace to the source of any errors.

Accordingly, there is a need for a more streamlined structure for vehicle software which can separate interfaces and variables into a more manageable and easy to control format.

### SUMMARY

According to one or more example embodiments, apparatuses and methods are provided for providing an interface for vehicle applications. In particular, the apparatus may include a memory storing instructions and at least one processor configured to execute the instructions to provide a layered application programming interface (API) including: a direct interface layer comprising at least one signal source; a unit conversion layer configured to receive signal data from at least one signal source and convert the signal data into a standardized format; and a processing layer configured to process the converted signal data from the unit conversion layer into processed signal data which can be interpreted by at least one application.

According to embodiments, the layered API may further include: a normalization layer configured to normalize converted signal data from the unit conversion layer into normalized signal data which is transmitted to at least one application. The normalized signal data may include a percentage. The converted signal data may include an image in a first dimension, and the normalized signal data may include an image in a second dimension different from the first dimension.

According to embodiments, the layered API may further include a signal validity layer configured to: combine a plurality of received signal data from a plurality of signal sources; and transmit a validity flag to at least one application based on determining the validity of the combined plurality of received signal. The validity flag may indicate whether the received signal data is valid or not. The validity flag may further indicate whether the received signal data is degraded or blocked.

According to embodiments, a method for providing an interface for vehicle applications may be provided. The method may include receiving, by a unit conversion layer of a layered application programming interface (API), signal data from at least one signal source of a direct interface layer of the layered API; converting, by the unit conversion layer, the received signal data into converted signal data in a standardized format; and processing, by a processing layer of the layered API, the converted signal data into processed signal data which can be interpreted by at least one application.

According to embodiments, the method may further include normalizing, by a normalization layer of the layered API, the converted signal data into normalized signal data; and transmitting, by the normalization layer, the normalized signal data to the at least one application. The normalized signal data may include a percentage. The converted signal data may include an image in a first dimension, and the normalized signal data may include an image in a second dimension different from the first dimension.

According to embodiments, the method may further include: combining, by a signal validity layer of the layered API, a plurality of received signal data from a plurality of signal sources; and transmitting, by the signal validity layer, a validity flag to the at least one application based on determining the validity of the combined plurality of received signals. The validity flag may indicate whether the received signal data is valid or not. The validity flag may further indicate whether the received signal data is degraded or blocked.

Additional aspects will be set forth in part in the description that follows and, in part, will be apparent from the description, or may be realized by practice of the presented embodiments of the disclosure.

### BRIEF DESCRIPTION OF THE DRAWINGS

Features, aspects and advantages of certain exemplary embodiments of the disclosure will be described below with reference to the accompanying drawings, in which like reference numerals denote like elements, and wherein:

FIG. 1 is a diagram of example components of a device according to an example embodiment;

FIG. 2 is a block diagram showing a generic layered application programming interface (API) stack according to one or more example embodiments;

FIG. 3 is a block diagram showing an example implementation of the layered API stack according to one or more example embodiments;

FIG. 4 is a flowchart diagram showing a method for converting sensor data received from a direct interface layer towards the application, according to one or more example embodiments;

FIG. 5 is a flowchart diagram showing a method for converting application instructions towards the direct interface layer, according to one or more example embodiments;

FIG. 6 is a flowchart diagram showing a method for using the signal validity layer, according to one or more example embodiments; and

FIG. 7 is a flowchart diagram showing a method for automatic interface description language (IDL) file generation, according to one or more example embodiments.

### DETAILED DESCRIPTION

The following detailed description of example embodiments refers to the accompanying drawings. The disclosure provides illustration and description, but is not intended to be exhaustive or to limit one or more example embodiments to the precise form disclosed. Modifications and variations are possible in light of the disclosure or may be acquired from practice of one or more example embodiments. Further, one or more features or components of one example embodiment may be incorporated into or combined with another example embodiment (or one or more features of another example embodiment). Additionally, in the flowcharts and descriptions of operations provided herein, it is understood that one or more operations may be omitted, one or more operations may be added, one or more operations may be performed simultaneously (at least in part), and the order of one or more operations may be switched.

It will be apparent that example embodiments of systems and/or methods and/or non-transitory computer readable storage mediums described herein may be implemented in different forms of hardware, firmware, or a combination of hardware and software. The actual specialized control hardware or software code used to implement these systems and/or methods is not limiting of one or more example embodiments. Thus, the operation and behavior of the systems and/or methods and/or non-transitory computer readable storage mediums are described herein without reference to specific software code. It is understood that software and hardware may be designed to implement the systems and/or methods based on the descriptions herein.

Even though particular combinations of features are recited in the claims and/or disclosed in the specification, these combinations are not intended to limit the disclosure of possible example embodiments. In fact, many of these features may be combined in ways not specifically recited in the claims and/or disclosed in the specification. Although each dependent claim listed below may directly depend on only one claim, the disclosure of possible example embodiments includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

A layered API according to example embodiments may include a process for generating code using interface definition language (IDL). In particular, apparatuses and methods according to example embodiments may include a direct interface layer comprising at least one signal source; a unit conversion layer configured to receive signal data from at least one signal source and convert the signal data into a standardized format; and a processing layer configured to process the converted signal data from the unit conversion layer into processed signal data which can be interpreted by at least one application. Additional layers such as a signal validity layer (for confirming the validity of data), and a normalization layer (for converting data into a more consistent format) may be included, depending on the specific application, nevertheless it should be noted that the specific arrangement of layers may depend on the specific application. In addition, apparatus and methods according to example embodiments may include a method for converting the API defined by the layered API in the form of a specification file, into code (such as an in an IDL format).

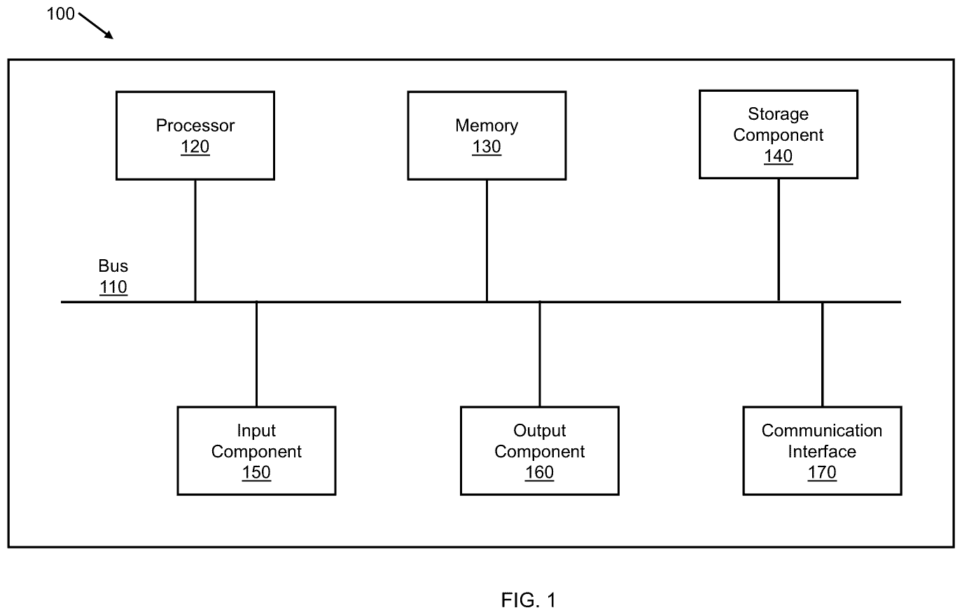

FIG. 1 is a diagram of example components of a device 100. As shown in FIG. 1 device 100 may include a bus 110, a processor 120, a memory 130, a storage component 140, an input component 150, an output component 160, and a communication interface 170.

Bus 110 includes a component that permits communication among the components of device 100. The processor 120 may be implemented in hardware, firmware, or a combination of hardware and software. Processor 120 may be a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In one or more example embodiments, the processor 120 includes one or more processors capable of being programmed to perform a function. The memory 130 includes a random access memory (RAM), a read only memory (ROM), and/or another type of dynamic or static storage device (e.g., a flash memory, a magnetic memory, and/or an optical memory) that stores information and/or instructions for use by the processor 220.

Storage component 140 stores information and/or software related to the operation and use of device 100. For example, the storage component 140 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive. Input component 150 includes a component that permits device 100 to receive information, such as via user input (e.g., a touch screen display, a keyboard, a keypad, a mouse, a button, a switch, and/or a microphone). Additionally, or alternatively, input component 150 may include a sensor for sensing information (e.g., a global positioning system (GPS) component, an accelerometer, a gyroscope, and/or an actuator). Output component 160 includes a component that provides output information from device 100 (e.g., a display, a speaker, and/or one or more light-emitting diodes (LEDs)).

The communication interface 170 includes a transceiver-like component (e.g., a transceiver and/or a separate receiver and transmitter) that enables device 100 to communicate with other devices, such as via a wired connection, a wireless connection, or a combination of wired and wireless connections. The communication interface 170 may permit the device 100 to receive information from another device and/or provide information to another device. For example, the communication interface 170 may include, but is not limited to, an Ethernet interface, an optical interface, a coaxial interface, an infrared interface, a radio frequency (RF) interface, a universal serial bus (USB) interface, a Wi-Fi interface, a cellular network interface, or the like.

The device 100 may perform one or more example processes described herein. According to one or more example embodiments, the device 100 may perform these processes in response to the processor 120 executing software instructions stored by a non-transitory computer-readable medium, such as the memory 130 and/or the storage component 140. A computer-readable medium is defined herein as a non-transitory memory device. A memory device includes memory space within a single physical storage device or memory space spread across multiple physical storage devices.

Software instructions may be read into the memory 130 and/or the storage component 140 from another computer-readable medium or from another device via the communication interface 170. When executed, software instructions stored in the memory 130 and/or the storage component 140 may cause the processor 120 to perform one or more processes described herein.

Additionally, or alternatively, hardwired circuitry may be used in place of, or in combination with, software instructions to perform one or more processes described herein. Thus, one or more example embodiments described herein are not limited to any specific combination of hardware circuitry and software.

The number and arrangement of components shown in FIG. 1 are provided as an example. In practice, the device 100 may include additional components, fewer components, different components, or differently arranged components than those shown in FIG. 1. Additionally, or alternatively, a set of components (e.g., one or more components) of the device 100 may perform one or more functions described as being performed by another set of components of the device 100.

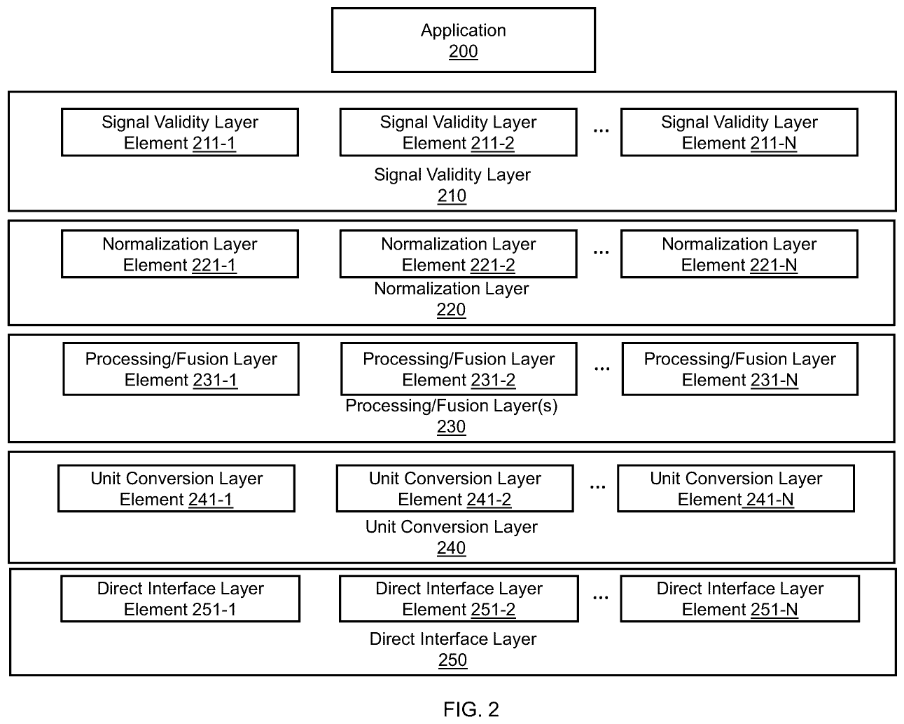

FIG. 2 is a block diagram showing a generic layered application programming interface (API) stack according to one or more example embodiments. The layered API may include application 200, and a plurality of abstraction layers (e.g., signal validity layer 210, normalization layer 220, processing/fusion layer 230, unit conversion layer 240, and direct interface layer 250).

According to embodiments, an abstraction layer for an API may be provided, which may control access to direct interface layer 250 (such as a sensor which may act as a signal source) in order to create more convenient interfaces for application 200 (such as an application that may be used in a vehicle). The direct interface layer 250 may comprise of one or more direct interface layer elements 250-1, 250-2, . . . 250-N, which each may correspond to different vehicle hardware/sensors. Each abstraction layer should include at least one input from either the direct interface layer 250 or another abstraction layer, however it should be appreciated that there may not be any upper limit to the number of inputs that a given abstraction layer may receive (aside from, for example, physical constraints). Each abstraction layer may include an output which may provide an output signal to another abstraction layer, the application 200, or to the direct interface layer 250. A plurality of abstraction layers may form a layered API, in order to bridge between the direct interface layer 250 and the application 200.

An abstraction layer at the lower end of the layer API stack (i.e., the closest to the direct interface layer 250) may receive the most amount of raw data, and during processing moving up the layer stack (i.e., toward the application 200), data may be more refined and the amount of data may be reduced.

According to embodiments, an example abstraction layer which may be at the lowest level is unit conversion layer 240. The unit conversion layer 240 may be configured to convert data which is in a format native to interfaces in the direct interface layer 250 (such as a sensor), to a standardized format (for example, an agreed-upon standard for an OEM or a supplier), or vice-versa. Unit conversion layer 240 may comprise of one or more elements (unit conversion layer elements 241-1, 241-2, . . . 241-N) which may be configured with different logic for handling conversions for different elements in the direct interface layer, according to embodiments.

As an example of using unit conversion layer 240, a vehicle speedometer may record sensor data for velocity in km/h (e.g., vehicle speedometer may be direct interface layer element 251-1), but the application 200 or another abstraction layer may require velocity data to be in a standardized m/s format. Accordingly, the unit conversion layer 240 may include an element (e.g., unit conversion layer element 241-1) including logic for converting km/h received from the direct interface layer 250 into m/s, for use by an upper abstraction layer.

As another example of using unit conversion layer 240, the application 200 or an upper abstraction layer may intend to actuate a brake, and provide braking force in standardized units of Newtons, but the brake actuators (as implemented in the direct interface layer) may only receive instructions in kgm/s\hat{ }2. Accordingly, unit conversion layer 240 may include an element for converting actuator force values received in Newtons from upper abstraction layers into kgm/s\hat{ }2 for the direct interface layer. The logic used in elements for unit conversion layer 240 may depend on the specific implementation.

According to embodiments, a processing/fusion layer 230 may be provided as another example abstraction layer. The processing/fusion layer 230 may receive one or more standardized data signals from a lower layer (these may be vehicle sensor specific data, such as from the unit conversion layer 240, or the direct interface layer 250 in the case where direct interface layer 250 already sends data in a standardized format), and perform processing to output data which is useful for an interface of the application 200 to use. Processing/fusion layer 230 may comprise of one or more elements (processing/fusion layer elements 231-1, 231-2, . . . 231-N) which may be configured with different logic for handling processing.

As an example of utilizing the processing/fusion layer 230, if the application 200 requires vehicle velocity, there may be more than one signal to check in order to confirm vehicle velocity (such as GPS velocity, and wheel speed). Accordingly, in an embodiment, an element in the processing/fusion layer 230 (e.g., processing/fusion layer element 231-1) may compare one signal against the other to check which sensor is more accurate, and provide the most accurate signal. According to another embodiment, an element in the processing layer 230 may provide a weighted average of the signals based on which sensor can be more trusted. In some cases, the output to the application from the element in the processing layer may also include a confidence rating regarding the quality of data provided based on performing the comparison.

As another example of using processing/fusion layer 230, an emergency braking function may be implemented. An element 231-1 in the processing/fusion layer 230 may receive input from multiple signal sources (e.g., Radar, LiDAR, a camera; either from the unit conversion layer 240 or from the direct interface layer 250), and only send a signal to application 200 if at least two of the signal sources indicate there is a detected oncoming object. Application 200, upon receiving the signal of a likely detected oncoming object, may send an instruction down the layered API stack (towards direct interface layer 250) to actuate a braking force using the direct interface layer 250, for the brakes to perform a braking maneuver.

According to some embodiments, processing/fusion layer 250 may be used for further data-type conversions outside of the standardized format received from direct interface layer 250 or unit conversion layer 240. For example, if a received camera input signal is in a RGB format and the application 200 requires a BRG format, an element in the processing/fusion layer 230 may perform a conversion between RGB and BRG format. Similarly, as another example, processing/fusion layer 230 may provide an element which performs conversion between Cartesian coordinates to Polar (or vice-versa).

It should be appreciated that while examples using a single processing/fusion layer is illustrated in FIG. 2 and described herein, a plurality of processing/fusion layers 230 may be used depending on the specific implementation (provided that the physical limitations of the system implementing the layered API stack are met). For instance, a first processing/fusion layer 230 could be dedicated towards processing camera data, whereas a second processing/fusion layer 230 could be dedicated towards further unit conversions.

According to embodiments, a normalization layer 220 may be provided as an abstraction layer, which may perform conversion of more vehicle-dependent data received from a lower layer (such as a unit conversion layer 240 or the direct interface layer 250) into a normalized data signal (a more consistent format) that is usable by application 200, or vice-versa. In particular, normalization layer 220 may be useful in scenarios where it is more convenient to portray data from the vehicle in a more human readable format at application 200, whereas the data from the vehicle may be harder to understand, or more difficult to use. Normalization layer 220 may be included or excluded depending on the specific implementation of the layered API stack. Normalization layer 220 may comprise of one or more elements (normalization layer elements 221-1, 221-2, . . . 221-N) which may be configured with different logic for handling different normalization process(es).

As an example of using normalization layer 220, braking calipers may have an interface at the direct interface layer 250, and an application 200 may intend to apply braking force to the braking calipers. However, from application 200's perspective, it may be difficult to specify the exact force, rather application 200 may simply quantify the braking force in terms of a percentage (0-100%, wherein 100% is to apply the maximum amount of braking force, and 0% is the minimum amount of braking force). It may also not be necessary for application 200 to include the specific braking force. Accordingly, an element (e.g., normalization layer element 221-1) in normalization layer 220 may be used to convert a percentage from application 200 into a force value (e.g., Newtons) at the lower abstraction layer (such as direct interface layer 250). It should be appreciated that a similar element may be used for implementing an accelerator (from percentage into accelerator actuation amount), or fan speed (from percentage to PWM/voltage).

As another example of using normalization 220, battery and fuel levels on a vehicle dashboard (which may be controlled by a vehicle application) may normally be displayed as a percentage, whereas the sensors may detect voltage and volume respectively. Accordingly, an element 221-1 in normalization 200 may be used to convert from the voltage/volume into a percentage.

As another example of using normalization layer 220, images received at the application 200 (for example, for use of a Convolutional Neural Network (CNN)) may require images to be of a specific dimension (e.g., 512×512 pixels). Meanwhile, images received from cameras as the direct interface layer 250 may be received in a different format (for example, 1024×768 pixels). Accordingly, an element 221-1 at the normalization layer 220 may be able to crop the image received at direct interface layer 250, or in some cases upscale the image from direct interface layer 250, and provide the processed image to application 200.

According to embodiments, a signal validity layer 210 may be provided as an abstraction layer. Signal validity layer 210 may intend to combine a plurality of received signal data from a plurality of signal sources (e.g., from the direct interface layer), and transmit a validity flag to the at least one application 200 based on whether the combined plurality of received signal data is valid or not. The signal validity layer 210 may be included or excluded depending on the specific implementation of the layered API stack. Signal validity layer 210 may comprise of one or more elements (signal validity layer elements 221-1, 221-2, . . . 221-N) which may be configured with different logic for handling signal validity verification process(es).

As an example of using signal validity layer 210, the signal sources (from direct interface 250 or a lower abstraction layer) may provide an engine indicator signal, a brake light indicator signal and a vehicle speed signal from a GPS. An element (e.g., signal validity layer element 211-1) at signal validity layer 210 may check if the indicator signal is on when the engine indicator signal is on, and the vehicle speed signal indicates the vehicle is not moving. If the brake light indicator signal is not on, then signal validity layer 210 may consider that at least one of the data signals is not valid, and transmit a validity flag to application 200 (indicating whether the data signal is valid or not).

As another example of using signal validity layer 210, the validity flag may not be a binary flag. For example, camera data could have multiple modalities/status indicator, such as, but not limited to, “Invalid”, “Degraded”, “Blocked”, or “functioning as expected”. For example, “Invalid” may refer to invalid data such as from a broken sensor, “Blocked” may refer to a case where the camera has detected it can't see anything. While the data from the data signal may still be considered as unusable, the difference in the status indicator indicating a broken sensor or a camera being blocked may be useful for application 200 to interpret for troubleshooting. “Degraded” could mean that the current conditions (e.g., environmental conditions while operating the vehicle) make it difficult for the sensor to detect objects with full confidence, but the data may not necessarily be simply dismissible by application 200. Accordingly, it should be appreciated that the validity flag used in signal validity layer 210 may be able to indicate to application 200 a wider variety of conditions, which may be useful for potential trouble-shooting or decision-making by application 200.

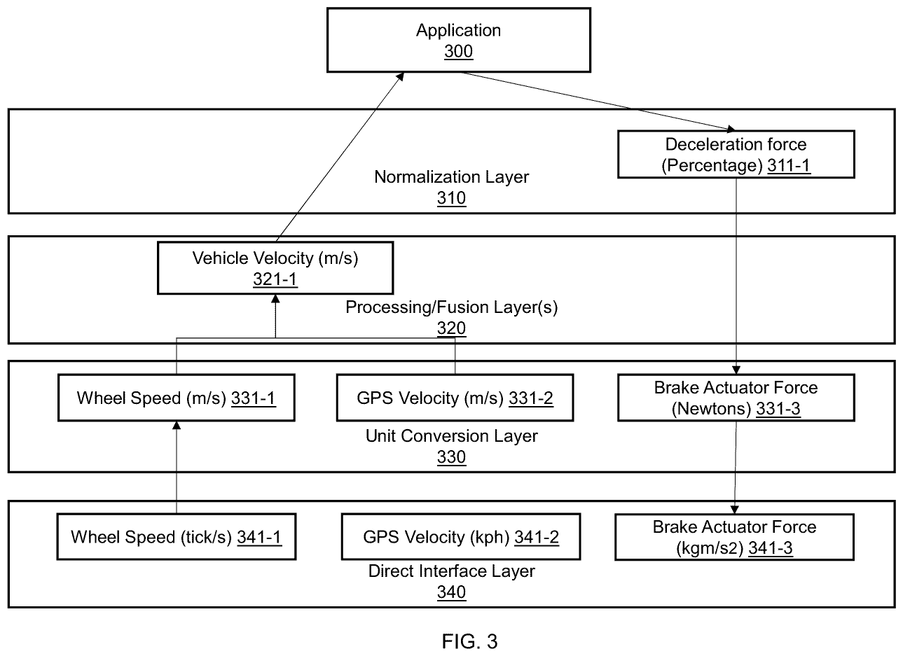

FIG. 3 is a block diagram showing an example implementation of the layered API stack according to one or more example embodiments. In the illustrated example, application 300, normalization layer 310, processing/fusion layer 320, unit conversion layer 330, and direct interface layer 340 is provided in the layered API stack (which may correspond to application 200, normalization layer 220, processing/fusion layer 230, unit conversion layer 240, and direct interface layer 250 as described in FIG. 2 above).

Direct interface layer 340 is provided, which collects Wheel Speed 341-1, GPS Velocity 341-2 in vehicle sensor native format of tick/s and kph respectively, and receives instructions to actuate braking force (Brake Actuator Force 341-3) in native format of kgm/s2.

Unit conversion layer 300, in element Wheel Speed 331-1, may convert tick/s received in Wheel Speed 341-1 into m/s, and like-wise GPS velocity 331-2 may convert kph received in GPS velocity 341-1 into m/s and send them to the processing/fusion layer 320. Unit conversion layer 330 may also convert Newtons received from normalization layer 310 using Brake Actuator Force 331-3 (from Deceleration force 311-1) into kgm/s2 to send to direct interface layer 340 in Brake Actuator Force 341-3.

Processing/fusion layer 320 may receive the two converted velocity signals in Vehicle Velocity 321-1 (e.g., Wheel Speed 331-1 and GPS Velocity 331-2), and determine which of the Wheel Speed 321-1 and GPS Velocity 331-2 is more accurate, and subsequently send the result to application 300.

Normalization layer 310 may receive a percentage for deceleration force from application 200 (in element Deceleration force 311-1), and convert the percentage into a brake actuator force in Newtons to send to Brake Actuator Force 331-3 in unit conversion layer 330.

Although not illustrated in FIG. 3, it should be appreciated that a signal validity layer (such as signal validity layer 210) could also be included (for example, directly below or above unit conversion layer 330). Further, while the abstraction layers shown in FIG. 3 are arranged in a certain way, it should be appreciated that in other implementations, the abstraction layers can be re-arranged, more processing/fusion layers 320 could be added, and some abstraction layers may be removed entirely.

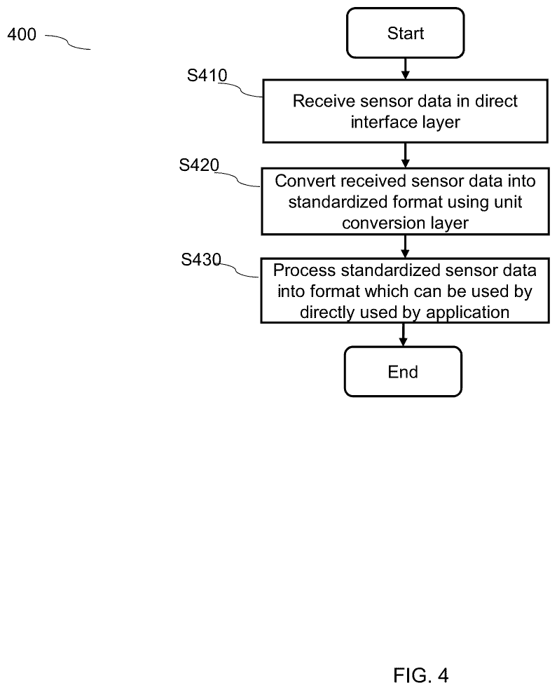

FIG. 4 is a flowchart diagram showing a method 400 for converting sensor data received from a direct interface layer towards the application, according to one or more example embodiments.

At operation S410, sensor data (or other data) may be received in a direct interface layer (such as direct interface layer 250, 340 as described above).

At operation S420, the sensor data received in operation S410 may be converted into a standardized format using an element in a unit conversion layer (such as unit conversion layer 240, 330 as described above).

At operation S430, the standardized sensor data from operation S420 may be processed into a format which may be usable by an application (such as application 200, 300 as described above). This may be performed by an upper abstraction layer, such as processing/fusion layer 230, 320, or normalization layer 220, 310 as described above.

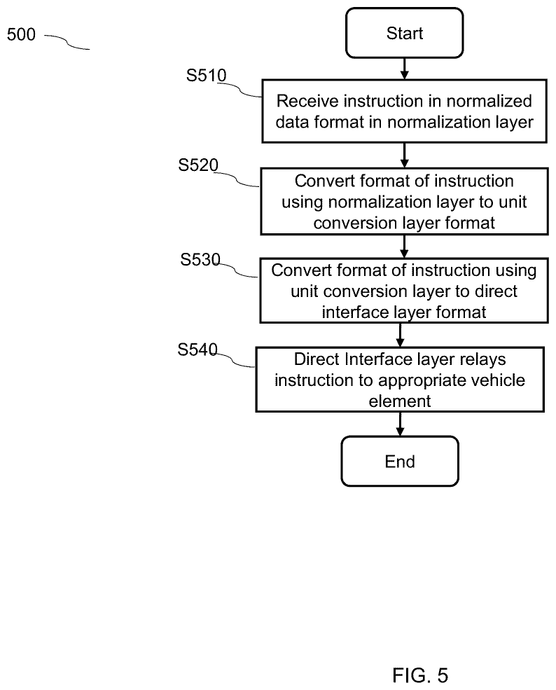

FIG. 5 is a flowchart diagram showing a method 500 for converting application instructions towards the direct interface layer, according to one or more example embodiments.

At operation S510, data indicating an instruction sent by an application (such as application 200, 300 as described above) may be received in a normalized data format in normalization layer (such as normalization layer 220, 310 as described above).

At operation S520, an element in the normalization layer may convert the format of the instruction to a standardized format used by a unit conversion layer (such as unit conversion layer 240, 330 as described above).

At operation S530, an element in the unit conversion layer may convert the format of the instruction from the standardized format in operation S520 into a native format which can be used by a direct interface layer (such as direct interface layer 250, 340 as described above).

At operation S540, the direct interface layer may relay the instruction to the appropriate vehicle element (for example, if the instruction was indicating applying deceleration force, the direct interface layer may provide the appropriate braking force to the brake calipers).

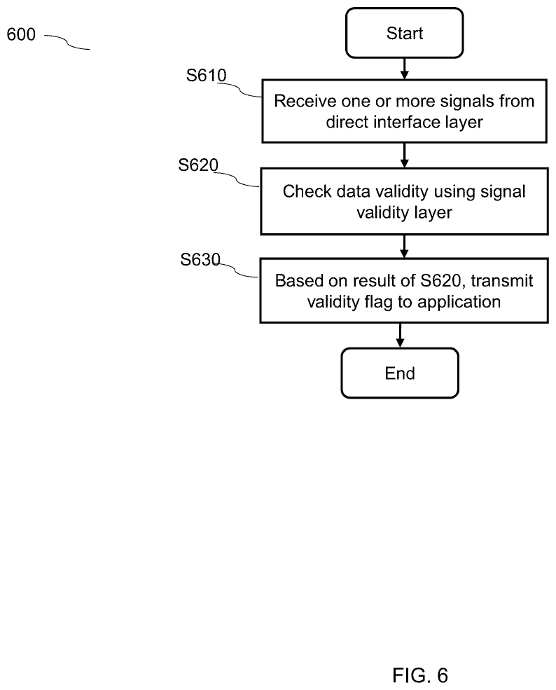

FIG. 6 is a flowchart diagram showing a method 600 for using the signal validity layer, according to one or more example embodiments.

At operation S610, one or more signals may be received from a direct interface layer (such as direct interface layer 250, 340 as described above).

At operation S620, a signal validity layer (such as signal validity layer 210 described above) may process the signals received in operation S610 to determine the validity of the data signal. According to embodiments, the processing may include comparing one or more signals based on predetermined logic.

At operation S630, based on the result of operation S620, a validity flag may be transmitted to an application (such as application 200, 300 as described above). According to embodiments, the validity flag may indicate a binary validity (either the data is valid or not). According to embodiments, the validity flag may be a status indicator of the data, which may further indicate whether the data is degraded or blocked.

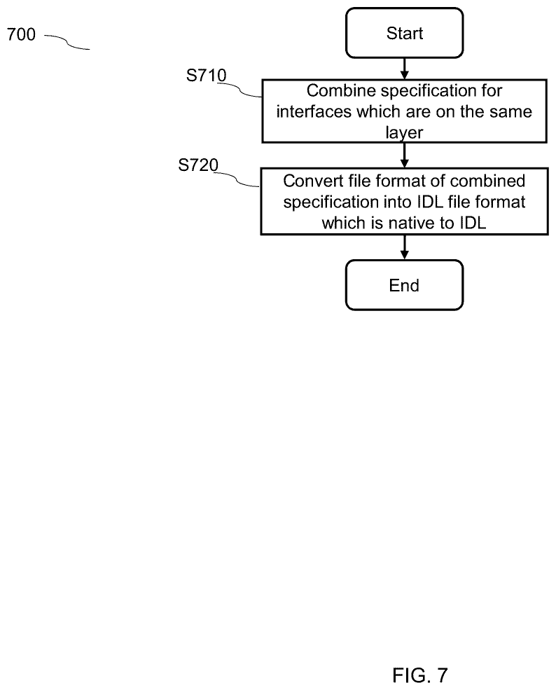

FIG. 7 is a flowchart diagram showing a method 700 for automatic interface description language (IDL) file generation, according to one or more example embodiments.

According to embodiments, one or more of the interfaces provided (such as hardware) or an abstraction layer may be initially described in terms of a specification (e.g., a specification defined in a standard JSON format), whereas the generated API for each abstraction layer of the layered API may be in an interface description language (IDL) file native to the operation. Accordingly, in order to generate the appropriate abstraction layer, a process defined in method 700 may be used.

At operation S710, the specification for interfaces which are on the same abstraction layer may be combined.

At operation S720, the file format of the combined specification from operation S710 may be converted into the native file format of the IDL

Based on the above, it can be understood that since the abstraction layers are distinct from the hardware layers (the direct interface layer), testing of the software may be performed independent of hardware. The overall complexity of a vehicle application may be simplified, since what is received from the application is independent of any unit conversions or data processing resulting from hardware specific configurations. Further, API's for each layer may have code automatically generated, further simplifying the amount of work needed to be performed by the software developer.

The foregoing disclosure provides illustration and description, but is not intended to be exhaustive or to limit one or more example embodiments to the precise form disclosed. Modifications and variations are possible in light of the disclosure or may be acquired from practice of one or more example embodiments.

One or more example embodiments may relate to a system, a method, and/or a computer readable medium at any possible technical detail level of integration. Further, one or more of the components described above may be implemented as instructions stored on a computer readable medium and executable by at least one processor (and/or may include at least one processor). The computer readable medium may include a computer-readable non-transitory storage medium (or media) having computer readable program instructions thereon for causing a processor to carry out operations.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In one or more example embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible example embodiments of systems, methods, and computer readable media according to one or more example embodiments. In this regard, each block in the flowchart or block diagrams may represent a microservice(s), module, segment, or portion of instructions, which comprises one or more executable instructions for implementing the specified logical function(s). The method, computer system, and computer readable medium may include additional blocks, fewer blocks, different blocks, or differently arranged blocks than those depicted in the drawings. In one or more alternative example embodiments, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of one or more example embodiments. Thus, the operation and behavior of the systems and/or methods were described herein without reference to specific software code—it being understood that software and hardware may be designed to implement the systems and/or methods based on the description herein.

What is claimed is:

1. An apparatus for providing an interface for vehicle applications, the apparatus comprising:
a memory storing instructions; and
at least one processor configured to execute the instructions to provide a layered application programming interface (API) comprising:
a direct interface layer comprising at least one signal source;
a unit conversion layer configured to receive signal data from at least one signal source and convert the signal data into a standardized format; and
a processing layer configured to process the converted signal data from the unit conversion layer into processed signal data which can be interpreted by at least one application.

2. The apparatus of claim 1, wherein the layered API further comprises:
a normalization layer configured to normalize converted signal data from the unit conversion layer into normalized signal data which is transmitted to at least one application.

3. The apparatus of claim 2, wherein the normalized signal data comprises a percentage.

4. The apparatus of claim 2, wherein the converted signal data comprises an image in a first dimension, and the normalized signal data comprises an image in a second dimension different from the first dimension.

5. The apparatus of claim 1, wherein the layered API further comprises a signal validity layer configured to:
combine a plurality of received signal data from a plurality of signal sources; and
transmit a validity flag to at least one application based on determining the validity of the combined plurality of received signal.

6. The apparatus of claim 5, wherein the validity flag indicates whether the received signal data is valid or not.

7. The apparatus of claim 6, wherein the validity flag may further indicate whether the received signal data is degraded or blocked.

8. A method for providing an interface for vehicle applications, the method comprising:
receiving, by a unit conversion layer of a layered application programming interface (API), signal data from at least one signal source of a direct interface layer of the layered API;
converting, by the unit conversion layer, the received signal data into converted signal data in a standardized format; and
processing, by a processing layer of the layered API, the converted signal data into processed signal data which can be interpreted by at least one application.

9. The method of claim 8, further comprising:
normalizing, by a normalization layer of the layered API, the converted signal data into normalized signal data; and
transmitting, by the normalization layer, the normalized signal data to the at least one application.

10. The method of claim 9, wherein the normalized signal data comprises a percentage.

11. The method of claim 9, wherein the converted signal data comprises an image in a first dimension, and the normalized signal data comprises an image in a second dimension different from the first dimension.

12. The method of claim 8, further comprising:
combining, by a signal validity layer of the layered API, a plurality of received signal data from a plurality of signal sources; and
transmitting, by the signal validity layer, a validity flag to the at least one application based on determining the validity of the combined plurality of received signals.

13. The method of claim 12, wherein the validity flag indicates whether the received signal data is valid or not.

14. The method of claim 13, wherein the validity flag may further indicate whether the received signal data is degraded or blocked.

15. A non-transitory computer-readable recording medium having recorded thereon instructions to perform a method comprising:
receiving, by a unit conversion layer of a layered application programming interface (API), signal data from at least one signal source of a direct interface layer of the layered API;
converting, by the unit conversion layer, the received signal data into converted signal data in a standardized format; and
processing, by a processing layer of the layered API, the converted signal data into processed signal data which can be interpreted by at least one application.

16. The non-transitory computer-readable recording medium of claim 15, wherein the method further comprises:
normalizing, by a normalization layer of the layered API, the converted signal data into normalized signal data; and
transmitting, by the normalization layer, the normalized signal data to the at least one application.

17. The non-transitory computer-readable recording medium of claim 16, wherein the normalized signal data comprises a percentage.

18. The non-transitory computer-readable recording medium of claim 16, wherein the converted signal data comprises an image in a first dimension, and the normalized signal data comprises an image in a second dimension different from the first dimension.

19. The non-transitory computer-readable recording medium of claim 15, wherein the method further comprises:
combining, by a signal validity layer of the layered API, a plurality of received signal data from a plurality of signal sources; and
transmitting, by the signal validity layer, a validity flag to the at least one application based on determining the validity of the combined plurality of received signals.

20. The non-transitory computer-readable recording medium of claim 15, wherein the validity flag indicates whether the received signal data is valid, not valid, degraded, or blocked.
